(19) United States
(12) Patent Application Publication
(10) Pub. No.: US 2005/0286398 A1
(43) Pub. Date: Dec. 29, 2005

(54) Optical disc and discarding method thereof

(75) Inventors: Masahiro Higuchi, Gifu (JP); Yoshio Fukuno, Shiga (JP); Yasuhiro Kodama, Gifu (JP); Takanari Kusafuka, Gifu (JP); Yoshiaki Maeno, Gifu (JP)

Correspondence Address: ARENT FOX PLLC, 1050 CONNECTICUT AVENUE, N.W., SUITE 400, WASHINGTON, DC, 20036, US

(73) Assignees: SANYO ELECTRIC CO., LTD.; SANYO MAVIC MEDIA CO., LTD.

(21) Appl. No.: 11/159,349

(22) Filed: Jun. 23, 2005

(30) Foreign Application Priority Data
Jun. 25, 2004 (JP) 2004-187315

(51) Int. Cl. G11B 7/24

(52) U.S. Cl. 369/272.1; 369/275.1

(57) ABSTRACT

A substrate 12 consists of a transparent plastic made from polylactic acid as a material, and an optical disc 10 provided with the substrate 12 is heated up to a heat deflection temperature. As a result, the substrate 12 is softened, and pits 22 formed on a signal recording surface 20 of the substrate 12 are erased. Thus, data recorded on the optical disc 10 is unreadable, and even if the disc 10 is discarded, the optical disc 10 is never read carelessly in accordance with the disposal of the optical disc.

### BACKGROUND OF THE INVENTION

1. Field of the Invention

The present invention relates to an optical disc and a discarding method thereof. More specifically, the present invention relates to an optical disc such as a CD, a DVD, a Blu-ray Disc, and an advanced optical storage (AOD or HD DVD), etc. and a discarding method thereof.

2. Description of the Prior Art

An example of such a kind of conventional optical disc is disclosed in a Japanese Patent Laying-open No. 2000-11448 laid-open on Jan. 14, 2000.

As to a degradable optical recording medium of this patent document, a substrate and a protective layer are made of biodegradable plastic, and a reflection film employs aluminum.

However, in the prior art, the optical disc is readable until the optical disc is biodegraded and the pits thereon are erased, and therefore, there is a fear that the data is carelessly stolen. Thus, the optical disc can be discarded only when the data of the optical disc is made unreadable by damaging the optical disc, and so forth.

### SUMMARY OF THE INVENTION

Therefore, it is a primary object of the present invention to provide an optical disc and a discarding method that are able to discard an optical disc with ease and safety.

The invention according to claim 1 is a discarding method of the optical disc in which a substrate of the optical disc is formed of transparent plastic made from polylactic acid as a main raw material, comprising a step of: discarding the optical disc after erasure of the pits by leaving the optical disc at a temperature equal to or more than a heat deflection temperature of the transparent plastic for a predetermined time period.

In the invention according to claim 1, the substrate of the optical disc consists of the transparent plastic made from polylactic acid as a main raw material. When the optical disc is stored in an environment at a temperature equal to or more than the heat deflection temperature of the transparent plastic, the substrate is softened. As a result, the pits provided on the signal recording surface are erased, and it is possible to discard the optical disc with the data recorded on the optical disc erased without damaging the optical disc.

The invention of claim 2 is a discarding method of an optical disc according to claim 1, wherein the temperature is a temperature equal to or more than a glass transition temperature.

In the invention according to claim 2, when the optical disc is stored in an environment at a temperature equal to or more than the glass transition temperature of the transparent plastic forming the substrate, the substrate is softened faster than that of the heat deflection temperature, and therefore, it is possible to rapidly erase the pits on the substrate.

The invention of claim 3 is an optical disc utilized for a discarding method of an optical disc according to claim 1, wherein the optical disc has the substrate made from polylactic acid as a main raw material with the pits erasable at a temperature equal to or less than 100° C.

The invention according to claim 3, it is possible to erase the pits formed on the substrate at temperatures equal to or less than 100° C., and therefore, by merely soaking the optical disc in hot water having a temperature higher than heat deflection temperature, it is possible to erase the data on the optical disc safely and simply.

According to the present invention, by applying heat to the optical disc, the data (pits) of the optical disc is easily erased, and made unreadable before the optical disc is discarded. Thus, the data is never read out carelessly in accordance with the disposal of the optical disc.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view showing an optical disc of one embodiment of the present invention;

FIG. 2 (A) is a sectional view showing an optical disc of another embodiment of the present invention;

FIG. 2 (B) is a graph showing reflection characteristics of a multilayer film of iron applied to a reflection film of the optical disc shown in FIG. 2 (A);

FIG. 3 is a graph showing a depth of pits of an optical disc applying LACEA to a substrate;

FIG. 4 (A) is a sectional view showing a signal recording surface of the optical disc;

FIG. 4 (B) is a sectional view showing the signal recording surface of the optical disc after the optical disc is left at a temperature of 60° C. for 15 minutes;

FIG. 4 (C) is a sectional view showing the signal recording surface of the optical disc after the optical disc is left at a temperature of 60° C. for 30 minutes;

FIG. 4 (D) is a sectional view showing the signal recording surface of the optical disc after the optical disc is left at a temperature of 60° C. for 45 minutes;

FIG. 5 is a perspective view showing a state where the optical disc in FIG. 1 embodiment is stored in a storage case and a film; and

FIG. 6 is a sectional view showing the optical disc, the storage case, and the film shown in FIG. 5.

### DETAILED DESCRIPTION OF THE PREFERRED EMBODIMENTS

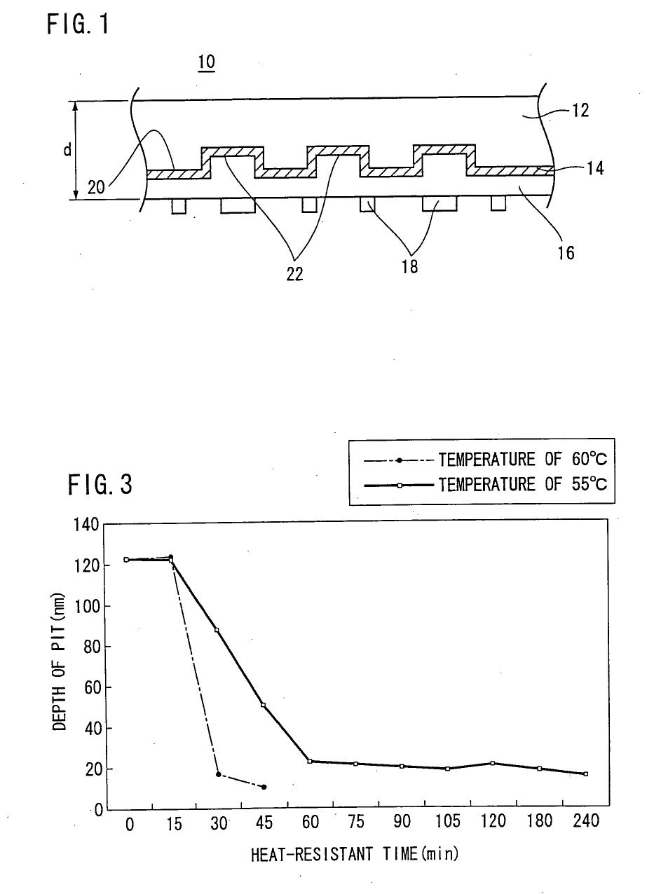

An optical disc 10 of one embodiment of the present invention shown in FIG. 1 is a disc having a reflection film 14, a base printing layer 16 and a label printing layer 18 in a laminated manner in this order on the substrate 12.

The substrate 12 is a circular plate, provided with pits 22 as a signal recording surface 20, and consists of transparent plastic which is degraded in the natural world. The plastic degraded in the natural world is a biodegradable plastic degraded by a microbe, and a plastic degraded by a water content, ultraviolet rays, etc. A typical transparent biodegradable plastic includes a plastic made from polylactic acid as a main raw material. Examples of such a material includes: “LACTY (product name)” manufactured by Toyota Motor Corporation, “LACEA (product name)” manufactured by Mitsui Chemicals, and “TERRAMAC” manufactured by Unitika Ltd.

The reflection film 14 is formed on the signal recording surface 20 of the substrate 12. The reflection film 14 is made of any one of a material degraded in the natural world such as a material degraded by oxygen, water, or the like and a material present in the natural world such as deposited minerals, or the like. Example of such the film includes a single layer film or a multilayer film of aluminum, gold, and silver. An aluminum thin film has a thickness of 40 nm, and an aluminum thin film including titanium of 1% by weight has a thickness of 35 nm. In a case of utilizing iron, because iron has a low reflectivity, a multi-layer film laminating an iron thin film 14a, a silicon oxide thin film 14b, and a silicon thin film 14c is utilized. In this case, the iron thin film has a thickness of 150 nm, the silicon oxide thin film has a thickness of 100 nm, and the silicon has a thickness of 45 nm.

The base printing layer 16 is directly formed on the reflection film 14, and covers at least a portion (area) of the signal recording surface 20 on which signals are recorded. The label printing layer 18 is formed on the base printing layer 16. The base printing layer 16 and the label printing layer 18 each consist of any one of a material degraded in the natural world such as biodegradable plastic, soybean oil, starch, and a material present in the natural world. Examples of such a material include “BIOTECH COLOR (product name)” produced by Dainichiseika Color & Chemicals Mfg. Co., Ltd., and “NEXT GP (product name)” produced by TOYO INK MFG. CO., LTD. As to the thickness of these layers, the base printing layer has a thickness of 4-6 μm, and the label printing layer has a thickness of 6-9 μm.

In a case of producing the optical disc 10, a substrate with the pits 22 transferred on one side thereof is formed through injection molding of the plastic degraded in the natural world. Then, the reflection film 14 is formed on the signal recording surface 20 through vacuum evaporation, sputtering, or the like. Furthermore, the base printing layer 16 and the label printing layer 18 are sequentially formed through silk-screen printing, or the like.

Such the optical disc 10 employing any one of the material degraded in the natural world and the material present in the natural world does not generate toxic gas through incineration in waste disposal of the optical disc, and further degrades in landfill disposal spontaneously, thereby reducing environmental loads such as air pollution and land pollution, etc.

Furthermore, the aluminum film applied to the reflection film 14 has a thickness of 40 nm, and is thinner than a normal film of 70 nm. The weight ratio is a ratio of the weight 16.7 g of the aluminum thin film having a thickness of 40 nm to the weight 1.2 mg of the disc itself, that is, 0.007%, and the weight ratio as to the normal thin film becomes 0.012%. Here, the specific weight of aluminum shall be 2.7. The aluminum film having a reflectivity of equal to or more than 90% satisfies reflection characteristics of the optical disc. Thus, it is possible to make the reflection film 14 thinner within the permissive range, capable of decreasing environmental loads.

Then, in a case of applying the thick film of titanium-containing aluminum to the reflection film 14, the reflectivity of the thick film of titanium-containing aluminum is higher than that of the single layer film made of aluminum, and therefore the reflection film 14 can be made thinner. The thinner the thin film is, the faster the reflection film 14 is degraded in the natural world.

Furthermore, the iron multilayer film 14a, 14b and 14c applied to the reflection film 14 undergoes oxidation and is degraded faster than a case where the aluminum film reacts to oxygen in the atmosphere, but takes a long time to undergo oxidation because the aluminum film forms a layer of oxide on its surface that prevents aluminum from being degraded. Thus, it is possible to decrease the environmental loads in comparison with the aluminum film.

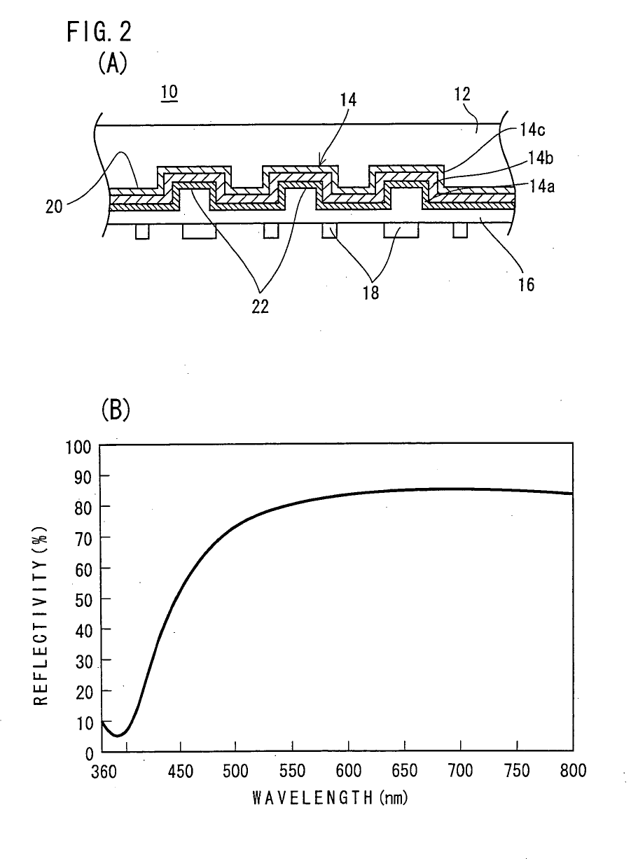

As shown in a graph representing the reflection characteristics of the iron multilayer film in FIG. 2 (B), as to a wavelength of the CD having 780 nm (horizontal axis) and a wavelength of the DVD having 650 nm, the reflectivity (vertical axis) is as high as about 85%. As to a wavelength of the Blu-ray Disc and the AOD having 405 nm, the reflectivity is as low as about 10%. However, since the reflectivity of these discs is defined as a small level, it is enough to perform disc reproduction and recording.

Then, the base printing layer 16 is directly formed on at least an area of the reflection film 14 on which signals are recorded such that the base printing layer 16 protects the reflection film 14, especially the area on which signals are recorded, and therefore, it is possible to eliminate necessity of providing a protective layer. Thus, it is possible to simplify manufacturing control and production process, thus reducing a manufacturing time and cost.

A total thickness of the base printing layer 16 and the label printing layer 18 is 10-15 μm. However, as a general, the protective layer has a thickness of 7 μm, and the label printing layer 18 has a thickness of 15 μm. Thus, it becomes possible to make the layer covering the reflection film 14 thin as a total. The thinner these layers 16 and 18 are, the faster the layer itself degrades, and the faster the reflection film 14 on which these layers are laminated also degrades.

Furthermore, a glass transition temperature of LACEA utilized in the substrate 12 of the optical disc 10 is 60° C., and a heat deflection temperature thereof is 53° C. Thus, the glass transition temperature of LACEA is lower than a glass transition temperature of resins such as polycarbonate, ARTON, or the like conventionally applied to the substrate 12. By utilizing such a feature, if the temperature higher than the glass transition temperature is applied to the optical disc 10, the data formed on the signal recording surface 20 of the substrate 12 is erased. Thus, it is possible to discard the optical disc 10 with the data irreproducible without damaging the optical disc 10. Especially, even when a facility such as a heating chamber is not provided like at home, and etc., the temperature to be applied to the optical disc 10 may be as low as 60-80° C. rather than 100° C. or more, and by merely soaking the optical disc 10 in hot water having temperatures higher than the heat deflection temperature or the glass transition temperature of the resin for a predetermined time period, it is possible to erase the pits, causing a data irreproducible state more safely and simply than damaging the optical disc 10.

That is, as shown in FIG. 3, when the optical disc 10 employing LACEA as a substrate 12 is left in the heating chamber at a temperature of 55° C. being the heat deflection temperature at a humidity of 40%, the depth of the pit 22 formed on the signal recording surface 20 of the substrate 12 is decreased as a lapse of time. The pit 22 has a maximum depth of about 125 nm at first, starts to drastically decrease due to softening of the substrate 12 after the optical disc is left in the heating chamber at a temperature of 55° C. at a humidity of 40% for 15 minutes, becomes a maximum depth of about 20 nm after 60 minutes, and slowly decreases the depth thereafter. Thus, where the optical disc 10 is heated for 60 minutes or more at a temperature of 55° C. or more, the pit 22 is flattened, which erases the data of the optical disc 10. It is possible to discard the optical disc with the data recorded in the optical disc unreadable.

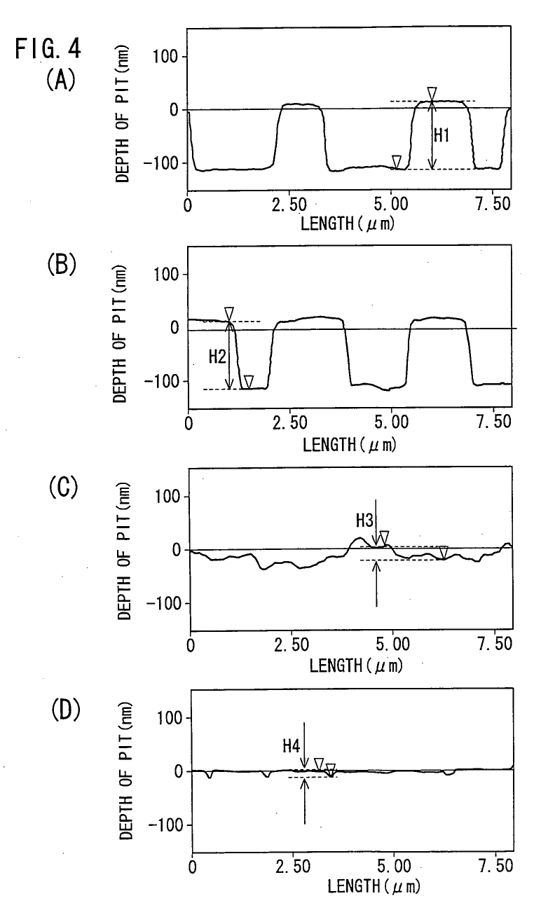

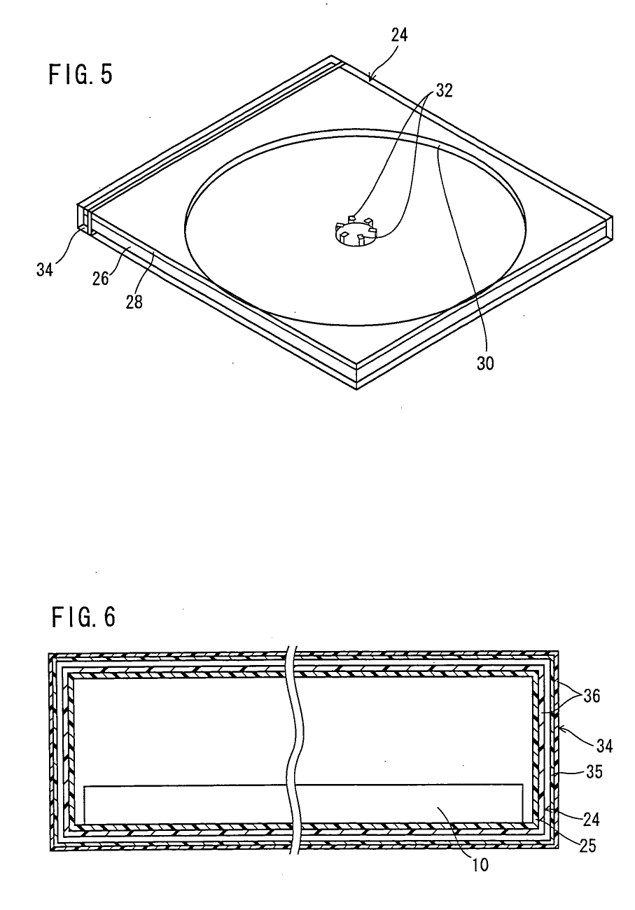

Furthermore, when the optical disc 10 provided with pits 22 of a maximum depth H1 of approximately 125 nm shown in FIG. 4 (A) is left at a humidity of 40% at a temperature of 60° C. the same as the glass transition temperature of the optical disc 10, the substrate 12 starts to soften in a matter of 15 minutes after heating, but the depth H2 of the pit is not changed as shown in FIG. 4 (B). Then, after a lapse of 30 minutes, the substrate 12 is sharply softened, and the pit thereof has a maximum depth H3 of approximately 17 nm as shown in FIG. 4 (C). After a lapse of 45 minutes, the pit has a maximum depth H4 of approximately 11 nm as shown in FIG. 4 (D). In the experiment, the maximum height of the signal recording surface 20 is measured by an atomic force microscope, and after a lapse of 30 minutes, the depth of the pit 22 is as high as approximately 10 nm, but the surface shape of the signal recording surface 20 takes an irregular shape as shown in FIG. 4 (C) and FIG. 4 (D). This makes it difficult to identify the position of the pits, and means that the data is erased. Thus, when the optical disc 10 is heated at a temperature of 60° C. or more for 30 minutes shorter than that in the heat deflection temperature, the pits 22 are erased, and therefore, it is possible to discard the optical disc with the data recorded on the optical disc unreadable.

As shown in FIG. 5, a storage case 24 for storing the optical disc 10 is provided with a base 26 and a cover 28. The base 26 is provided with a hole 30 and holding portions 32 for holding the optical disc 10, and the holding portions 32 are located at the center of the hole 30. As shown in FIG. 6, the storage case 24 has a two-layered structure, the inner layer 25 on the disc holding side employs a plastic degraded in the natural world, and the outer surface 36 employs an ultraviolet curing plastic of acrylic. The outer surface 36 is formed such that the outer surface of the inner layer 25 is covered with the ultraviolet curing plastic of acrylic, etc. through dipping and injection, and functions as a protective layer of the case.

The storage case 24 is covered with a transparent and thin film 34. As shown in FIG. 6, the film 34 has a two-layered structure, an inner layer 35 opposed to the storage case 24 employs a plastic degraded in the natural world, and the outer surface 36 employs an ultraviolet curing plastic of acrylic. Similarly to the storage case 24, the outer surface 36 is formed such that the outer surface of the inner layer 25 is covered with the ultraviolet curing plastic of acrylic, etc. through dipping and injection, and functions as a protective layer of the case.

The storage case 24 and the film 34 are formed of a plastic degraded in the natural world, but its outer surface 36 is formed of an ultraviolet curing plastic of acrylic, etc., and shuts off air, water content, and the like, and therefore, the optical disc 10 is not degraded. Thus, it is possible to store the optical disc 10 for a long time. It is noted that in a case that the storage case 24 and the film 34 are discarded, the inner layers 25, 35 degrade at first, and therefore, it is possible to reduce environmental loads to a small amount.

It is noted that although the base printing layer 16 is formed on at least an area of the signal recording surface 20 on which signals are recorded, it may entirely cover the reflection film 14.

Furthermore, although the base printing layer 16 is directly formed on the reflection film 14, the protective layer may be provided between the reflection film 14 and the base printing layer 16 in place of this.

In addition, although the outer surface 36 employing ultraviolet curing plastic of acrylic is provided on the storage case 24 and the film 34, it needs not be provided.

Although the present invention has been described and illustrated in detail, it is clearly understood that the same is by way of illustration and example only and is not to be taken by way of limitation, the spirit and scope of the present invention being limited only by the terms of the appended claims.

1. A discarding method of an optical disc in which a substrate of said optical disc is formed of transparent plastic made from polylactic acid as a main raw material, comprising a step of:
discarding said optical disc after erasure of said pits by leaving said optical disc at a temperature equal to or more than a heat deflection temperature of said transparent plastic for a predetermined time period.

2. A discarding method of an optical disc according to claim 1, wherein said temperature is a temperature equal to or more than a glass transition temperature.

3. An optical disc utilized for a discarding method of an optical disc according to claim 1, wherein said optical disc has the substrate made from polylactic acid as a main raw material with said pits erasable at a temperature equal to or less than 100° C.
